(19) United States
(12) Patent Application Publication
(10) Pub. No.: US 2002/0044589 A1
(43) Pub. Date: Apr. 18, 2002

(54) Semiconductor laser unit and optical pick-up device using the same

(76) Inventors: Kentaro Terashima, Kashiba-shi (JP); Takahiro Miyake, Soraku-gun (JP)

Correspondence Address: Dike, Bronstein, Roberts & Cushman LLP, 130 Water Street, Boston, MA, 02109, US

(21) Appl. No.: 09/975,594

(22) Filed: Oct. 11, 2001

(30) Foreign Application Priority Data
Oct. 12, 2000 (JP) 2000-312604

(51) Int. Cl. H01S 3/04; H01S 3/08

(52) U.S. Cl. 372/108; 372/36

(57) ABSTRACT

An aperture for shielding scattered light having an intensity of less than 1/e² of a peak value included in laser light emitted from a semiconductor laser is provided at a cap which houses a semiconductor laser and a photoreceptor. A semiconductor laser unit having less stray light incident and detected by the photoreceptor is provided by restraining light subjected to the Fresnel reflection in a hologram device located close to a light source.

### FIELD OF THE INVENTION

The present invention relates to a semiconductor laser unit, and an optical pick-up device which uses the unit for emitting laser light to an information recording medium such as an optical disk, and storing information on a recording surface of the information recording medium or reproducing information written on the information recording surface thereof.

### BACKGROUND OF THE INVENTION

Recently, in a field of information recording, research on the optical information recording method has been carried out in various places. The optical information recording method has various advantages, such that it can provide noncontact recording/reproduction on/from a recording medium, it can achieve recording density one or more orders of magnitude greater than that of the magnetic recording method, and it can handle respective optical disks of different memory types including a read-only type, a write-once type, and a rewritable type. Thus, the method has been considered to be utilized for a wide range of applications from industrial to consumer products, as means for realizing a mass-storage medium.

For example, an optical pick-up device adopting a hologram device is described in Sharp Technical Information No. 72 [published on December 1998: hereinafter referred to as a conventional technique (A)]. As shown in FIG. 12, light emitted from a semiconductor laser 101 is transmitted through a hologram device 102, collimated by a collimator lens 104, guided by an objective lens 105, then condensed on a recording medium 106.

Then, recording signal light reflected from the recording medium 106 is split by a beam splitter 103, into reflected light and transmitted light. The reflected light passes through a concave lens 107 and is condensed on a photoreceptor 108. With this arrangement, information recorded on the recording medium 106 can be read. The transmitted light, after passing through the beam splitter 103, enters the hologram device 102. Here, the transmitted light is diffracted by a hologram 109 formed on the hologram device 102 as shown in FIG. 13, then condensed on a photoreceptor 110.

The hologram 109 is divided into three regions: therefore, light passing through the hologram 109 is divided into three. The photoreceptor 110, which is divided into eight divided light receiving sections D1 to D8 as shown in FIG. 14, condenses the light divided into three by the hologram 109.

Here, the semiconductor laser 101 and the photoreceptor 110 are housed in a cap 111. The cap 111 has an opening section 111a for transmitting light from the hologram 109 into the cap 111. As shown in FIG. 15, the opening section 111a is designed considerably larger than light 112 emitted from the semiconductor laser 101, considering an error caused when installing the hologram device 102 on the cap 111.

FIG. 16 shows another conventional device disclosed in Japanese Unexamined Patent Publication No. 62-60140/1987 [Tokukaisho 62-60140, published on Mar. 16, 1987: hereinafter referred to as a conventional technique (B)]. Light emitted from a semiconductor laser 120 passes through a diffraction grating 121, and the diameter of the light is limited by an aperture 122. Then, the limited light passes through a splitter 123, and enters a collimator lens 124. The collimated light beam is condensed on an optical disk 126 by an objective lens 125. Light reflected from the optical disk 126 traces an optical path reverse to that of the incident light, and is reflected by the splitter 123 then enters an optical signal detector 127 so as to be converted into an electric signal.

Since the diameter of the light is limited by the aperture 122, the laser light enters the collimator lens 124 as shown with the dashed lines in FIG. 16, without impinging on an inner surface of a housing 128. This structure eliminates multiple reflection of the laser light inside the housing 128, thereby preventing stray light caused by the multiple reflection of the laser light from entering the optical signal detector 127 to be detected.

However, the foregoing structures have the following problems.

In the structure of the conventional technique (A), the light emitted from the semiconductor laser 101 enters the hologram device 102, and is emitted from the hologram device 102. Here, a part of the light is subjected to the Fresnel reflection on light incoming and outgoing surfaces of the hologram device 102. Since the hologram device 102 and the semiconductor laser 101 are located close, the Fresnel reflection cannot be avoided.

As shown in FIG. 13, the semiconductor laser 101 and the photoreceptor 110 are mounted on a common stem and housed in a package. Thus, when the light emitted from the semiconductor laser 101 is subjected to the Fresnel reflection, the light enters the photoreceptor 110 directly or indirectly.

In this manner, the photoreceptor 110 is prone to be influenced by stray light caused by the light from the semiconductor laser 101. With this structure, when detecting an error signal by the photoreceptor 110, scattered light enters the photoreceptor 110 besides signal light, causing plenty of signal noise. Consequently, relative intensity of the error signal with respect to noise (S/N) decreases, and control by a servo mechanism are likely to be placed on dispersed objects.

To solve the problem, conventionally, anti-reflection plating has been provided in the inner surface of the cap 111, the semiconductor laser 101 and the photoreceptor 110 have been located as far as possible, or AR coating has been provided on the light incoming and outgoing surfaces of the hologram device 102 so as to eliminate the light reflection in the hologram device 102 as much as possible. However, these efforts have not produced sufficient results.

In the structure of the conventional technique (B), the provision of the aperture 122 can prevent stray light caused after the light passes through the aperture 122, from entering the optical signal detector 127, which is a photoreceptor, and being detected. However, the Fresnel reflection light caused on the light incoming and outgoing surfaces of the diffraction grating 121 goes back toward the semiconductor laser 120, and when the optical signal detector 127 and the semiconductor laser 120 are located close, the Fresnel reflection light enters the optical signal detector 127. Thus, the S/N decreases, and control by a servo mechanism are likely to be placed on dispersed objects.

Incidentally, it is desirable that the S/N for operating a servo mechanism is set greater as much as possible, considering the decrease of servo signal light due to the misalignment of components constituting an optical pick-up device caused when installing the components, and other reasons. In the present consumer products manufactured by Sharp, a servo circuit can be simplified by improving the S/N by around 1 dB to 2 dB, consequently reducing manufacturing cost.

### SUMMARY OF THE INVENTION

It is therefore an object of the present invention to provide a semiconductor laser unit and an optical pick-up device having less stray light incident and detected by a photoreceptor, by restraining light subjected to the Fresnel reflection in an optical component located close to a light source.

To solve the above-mentioned problems, a semiconductor laser unit of the present invention, which is a semiconductor laser unit for emitting laser light from a semiconductor laser via a hologram device, and guiding the light incident on the hologram device to a photoreceptor, includes scattered light shielding means for shielding scattered light having an intensity of less than 1/e² of a peak value, of the laser light emitted from the semiconductor laser.

The laser light is emitted from the semiconductor laser. Generally, the laser light includes light having an intensity of not less than 1/e² of a peak value, which has an elliptical cross section, and the laser light also includes scattered light having an intensity of less than 1/e² of the peak value. The scattered light enters the photoreceptor in several ways: it enters the photoreceptor directly; it is reflected on the light incoming and outgoing surfaces of the hologram device, then enters the photoreceptor directly or indirectly as the Fresnel reflection light; or it is reflected on a material in the semiconductor laser unit (for example, on an inner surface of a cap) and enters the photoreceptor. Among the foregoing scattered light entering the photoreceptor, the amount of light which is reflected on the light incoming and outgoing surfaces of the hologram device and enters the photoreceptor as the Fresnel reflection light has an intensity which is not negligible.

When light other than the light which should be originally detected enters the photoreceptor in this manner, the detection accuracy of the photoreceptor is substantially deteriorated. Thus, if control (for example, the control by a servo mechanism) is carried out based on the light actually detected by the photoreceptor, reliability is significantly deteriorated.

However, according to the foregoing structure, the scattered light shielding means is provided so as to shield the scattered light having an intensity of less than 1/e² of the peak value. Therefore, the foregoing structure can surely reduce the amount of the scattered light which enters the photoreceptor directly or indirectly, by the amount of the shielded scattered light.

Meanwhile, a beam of the laser light having an intensity of not less than 1/e² of the peak value is emitted outside via the hologram device, without being interfered by the scattered light shielding means. Therefore, the reliability of the control carried out based on the light detected by the photoreceptor can be substantially improved, without decreasing the intensity of the emitted light.

An optical pick-up device of the present invention adopts a semiconductor laser unit for emitting laser light from a semiconductor laser via a hologram device and guiding light incident on the hologram device to a photoreceptor, which includes scattered light shielding means for shielding scattered light having an intensity of less than 1/e² of a peak value, of the laser light emitted from the semiconductor laser, wherein:

the light emitted from the semiconductor laser unit is guided to a recording medium, and light reflected from the recording medium is guided to the photoreceptor via the hologram device, so as to detect a servo error signal.

This structure can reduce stray light which is caused by the Fresnel reflection from the light incoming and outgoing surfaces of the hologram device and enters the photoreceptor, without interfering with servo error signal detection light diffracted by the hologram device. Therefore, a highly reliable servo mechanism can be surely provided.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is an explanatory view showing a structure of an optical pick-up device provided with a semiconductor laser unit in accordance with one embodiment of the present invention.

FIGS. 2(a) through 2(d) are detail views of a square, circular, rectangle, and elliptical aperture, respectively, used in the optical pick-up device shown in FIG. 1.

FIG. 3 is an explanatory view showing a structure of the semiconductor laser unit in the optical pick-up device shown in FIG. 1.

FIG. 4 is a graph showing stray light relative intensity when using a square aperture in the optical pick-up device shown in FIG. 1.

FIG. 5 is a detail view of an aperture.

FIG. 6 is an explanatory view showing a structure of a semiconductor laser unit in accordance with another embodiment of the present invention.

FIG. 7 is a detail view showing a shape of an aperture in the semiconductor laser unit shown in FIG. 6 used in an optical pick-up device.

FIG. 8 is an explanatory view showing the dimensions of a cap and a hologram device in the semiconductor laser unit shown in FIG. 6 used in the optical pick-up device.

FIG. 9 is a graph showing stray light relative intensity in the optical pick-up device provided with the semiconductor laser unit shown in FIG. 6, obtained by simulation.

FIG. 10 is an explanatory view showing a structure of a semiconductor laser unit provided with an aperture with shielding property formed on a light incoming surface of an hologram device.

FIG. 11 is a graph comparing stray light relative intensities obtained when an aperture is provided and when it is not provided, in an optical pick-up device provided with the semiconductor laser unit shown in FIG. 10.

FIG. 12 is an explanatory view showing a structure of a conventional optical pick-up device.

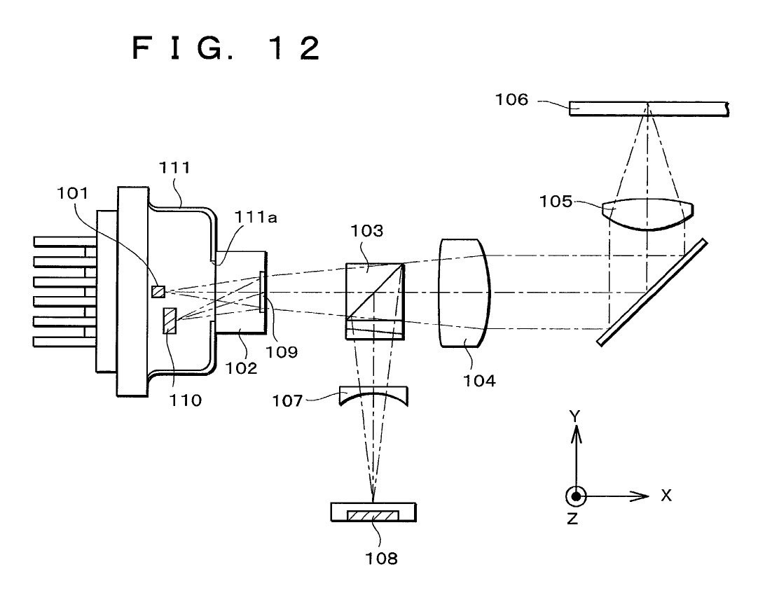

FIG. 13 is a perspective cross sectional view showing a structure including a hologram device, a semiconductor laser, and a photoreceptor in the optical pick-up device shown in FIG. 12.

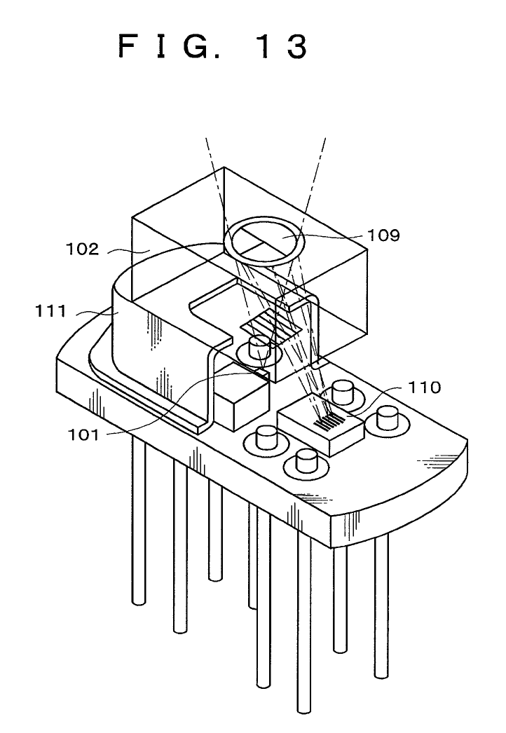

FIG. 14 is a detail view showing the photoreceptor of the optical pick-up device shown in FIG. 12.

FIG. 15 is an explanatory view showing a size of an opening section of a cap in the optical pick-up device shown in FIG. 12.

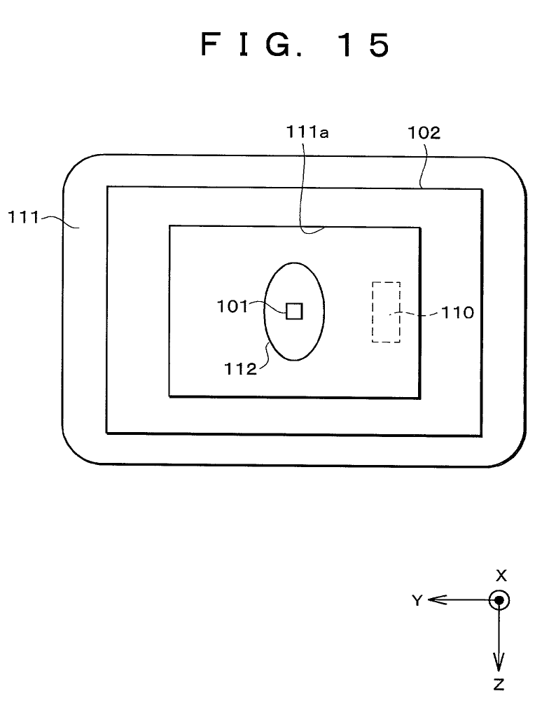

FIG. 16 is an explanatory view showing a structure of another conventional optical pick-up device.

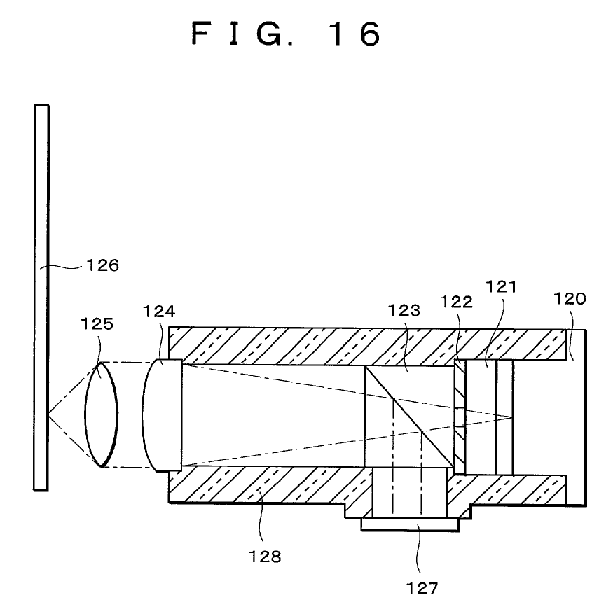

### DESCRIPTION OF THE PREFERRED EMBODIMENTS

### First Embodiment

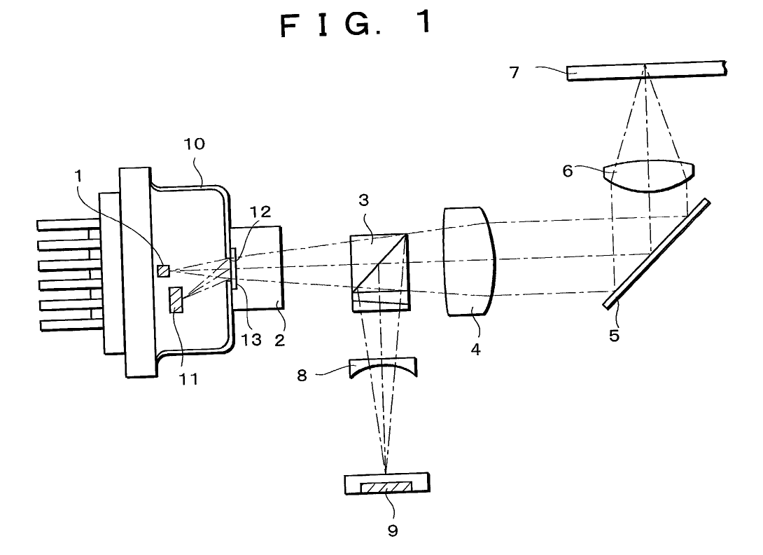

Referring to FIGS. 1 through 5 and 14, the following description will describe one embodiment of the present invention.

FIG. 1 is an explanatory view showing a structure of an optical pick-up device of the present embodiment. As shown in FIG. 1, the optical pick-up device is made up of a semiconductor laser 1, a hologram device 2, a splitter 3, a collimator lens 4, a mirror 5, an objective lens 6, a disk 7, a concave lens 8, a photoreceptor 9, a cap 10, and a photoreceptor 11. Among them, the semiconductor laser 1, the hologram device 2, the cap 10, and the photoreceptor 11 constitute a semiconductor laser unit.

The semiconductor laser 1 and the photoreceptor 11 are provided inside the cap 10. The cap 10 is provided with an aperture 12, which is an opening section, in an area where light emitted from the semiconductor laser 1 passes through. The hologram device 2 is provided on the cap 10, on the side having the aperture 12. The hologram device 2 has a hologram plane 13, which is larger than the aperture 12 and located so as to cover the aperture 12.

The light emitted from the semiconductor laser 1, which is a light source, passes through the aperture 12, then passes through the hologram device 2. Then, the light is guided to the splitter 3, passes through it, and enters the collimator lens 4. The light incident on the collimator lens 4 is converted to collimated light, reflected by the mirror 5 so as to change the moving direction, and enters the objective lens 6. The light passing through the objective lens 6 is condensed on the disk 7. Then, the light is reflected on the disk 7, and again passes through the objective lens 6, reflected by the mirror 5, and enters the collimator lens 4.

The light passing through the collimator lens 4 is split into reflected light which is reflected in the splitter 3 and transmitted light passing through the splitter 3. The reflected light reflected in the splitter 3 is received by the photoreceptor 9 via the concave lens 8. With this arrangement, information recorded on the disk 7 can be read.

The transmitted light passing through the splitter 3 enters the hologram device 2, and passes through the hologram plane 13, which is divided into three regions. The light diffracted by the hologram plane 13 is condensed on a multi-divided light-receptive section, which is divided into a plurality of regions, provided on the photoreceptor 11. In accordance with the result of the light reception, a radial error signal, a pit signal, and an ADIP (Address In Pregroove) signal are detected.

Generally, the light emitted from the semiconductor laser 1 enters the hologram device 2, then is emitted from the hologram device 2. Since the hologram device 2 and the semiconductor laser 1 are located close, a part of the light is subjected to the Fresnel reflection on light incoming and outgoing surfaces of the hologram device 2. The light subjected to the Fresnel reflection enters the photoreceptor 11.

The photoreceptor 11 is provided in the cap 10, along with the semiconductor laser 1. When the light emitted from the semiconductor laser 1 is subjected to the Fresnel reflection, the light reaches the photoreceptor 11. If light other than signal light enters the photoreceptor 11 when the photoreceptor 11 detects an error signal (a servo error signal), plenty of signal noise is caused. Thus, relative intensity of the error signal (the servo error signal) with respect to noise (S/N) decreases, deteriorating the reliability of a servo mechanism.

The following description will explain the light emitted from the semiconductor laser 1, and the aperture 12, in detail.

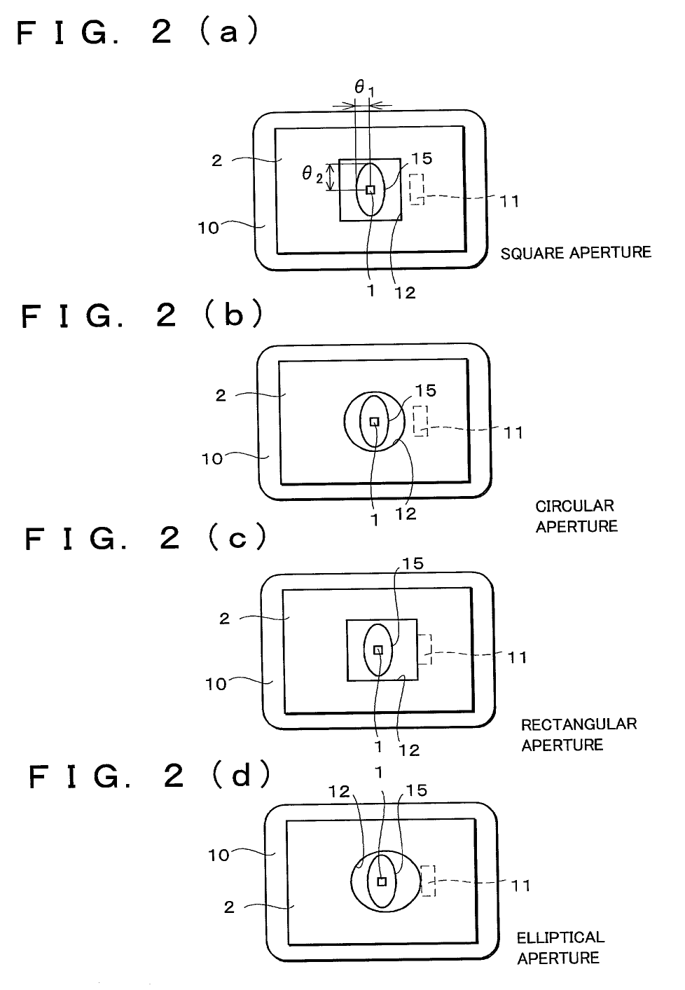

As shown in FIG. 2(a), the light emitted from the semiconductor laser 1 includes light 15 having an intensity of not less than 1/e² of a peak value, which has an elliptical cross section, and the foregoing emitted light also includes scattered light having an intensity of less than 1/e² of the peak value. The scattered light enters the photoreceptor 11 in several ways: it enters the photoreceptor 11 directly; it is reflected on the light incoming and outgoing surfaces of the hologram device 2, then enters the photoreceptor 11 directly or indirectly as the Fresnel reflection light; or it is reflected on an inner surface of the cap 10 and enters the photoreceptor 11.

Here, take θ₁ as a horizontal outgoing angle, which is a half angle of an outgoing angle corresponding to a minor axis of the cross section of the light 15, and take θ₂ as a vertical outgoing angle, which is a half angle of an outgoing angle corresponding to a major axis of the cross section of the light 15.

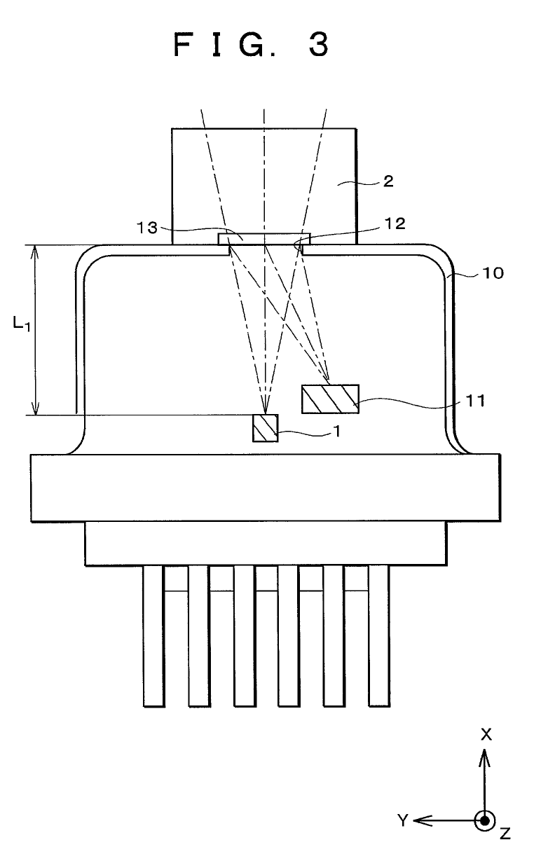

Besides, take L₁ as a distance between the semiconductor laser 1 and the hologram device 2, as shown in FIG. 3.

The light 15 having an intensity of not less than 1/e² of the peak value, included in the light emitted from the semiconductor laser 1, has an oval cross section with a minor axis of 2L₁·tanθ₁, and a major axis of 2L₁·tanθ₂, at the position of the aperture 12. The aperture 12 should be provided so as not to interfere with vertically emitted light which is emitted in a direction of the major axis of the oval cross section (in the Z-axis direction).

Therefore, it is desirable that the aperture 12 is formed in a square shape with a side longer than 2L₁·tanθ₂ as shown in FIG. 2(a), or in a circular shape with a diameter longer than 2L₁·tanθ₂ as shown in FIG. 2(b). That is, the aperture 12 may be sufficiently formed when it is a square with one side of Aₚ, or a circle inscribing the square (a circle with a diameter of Aₚ), satisfying the following inequality (1).

Aₚ>2L₁·tanθ₂ (1)

For example, when L₁=1.42 mm, and θ₂=24°, Aₚ is given as follows:

Aₚ>2×1.42×tan24°=1.26 mm.

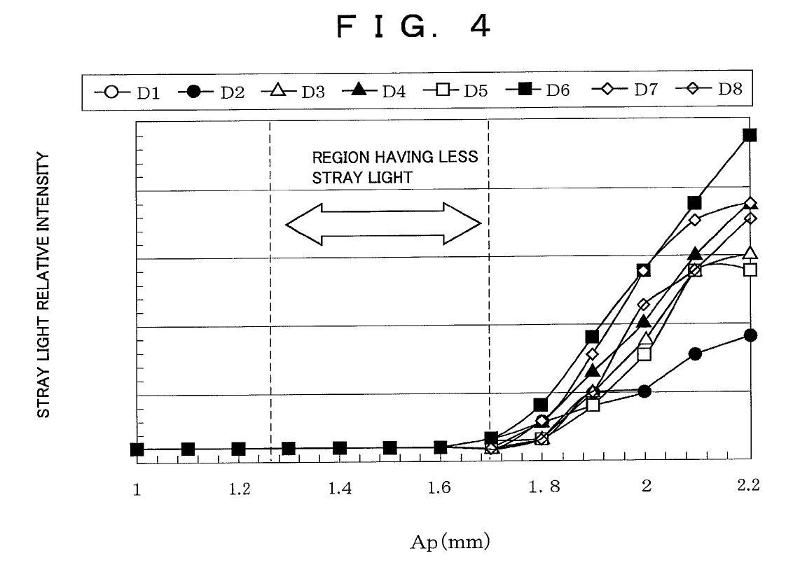

FIG. 4 is a graph of stray light intensity in an optical pick-up device having the square-shaped aperture 12 with one side of Aₚ shown in FIG. 2(a), obtained by simulation. The horizontal axis denotes the length of one side Aₚ of the aperture 12, and the vertical axis denotes the stray light relative intensity.

The conditions used for the simulation are as follows:

Simulation method: Monte Carlo simulation

(the number of light beams: 10⁵)

FFP of the semiconductor laser 1:

θ₁(in the Y-axis direction in FIG. 3)=8°

θ₂(in the Z-axis direction in FIG. 3)=24°

L₁=1.42 mm

Surface reflectance:

Stem surface 35%

Inner surface of the cap 10 10%

Standardized by the light emitted from the collimator lens 4 (100%)

AR coating is provided on light incoming and outgoing surfaces of the hologram device 2, the splitter 3, and the collimator lens 4.

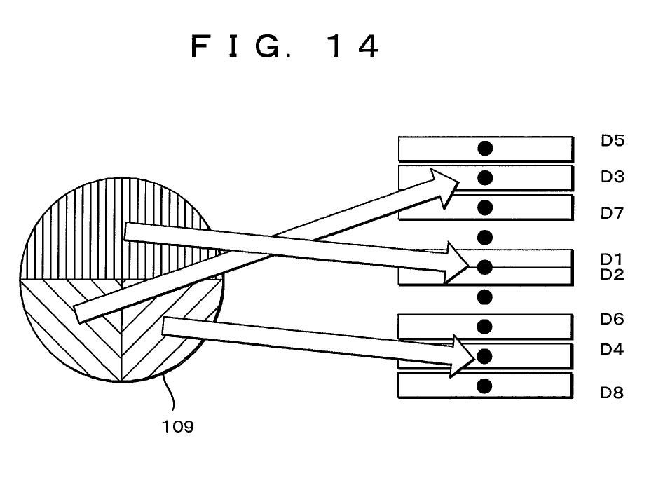

The photoreceptor 11 is divided into eight regions (see FIG. 14).

As shown in FIG. 4, when Aₚ<1.7 mm, the increase of the stray light is restrained. Aₚ should satisfy the inequality (1), and it turns out that Aₚ>1.26 mm under the foregoing conditions. Thus, the maximum Aₚ value of 1.7 mm, until which the increase of the stray light is restrained, is about 35 percent greater than the minimum Aₚ value of 1.26 mm. Therefore, the one side Aₚ of the aperture 12 can be defined so as to satisfy the following inequality (2):

2L₁·tanθ₂<Aₚ<2.7L₁·tanθ₂. . . . (2)

That is, by satisfying the foregoing inequality (2), the aperture 12 does not interfere with a light beam emitted at an angle within the horizontal outgoing angle of θ₁ and within the vertical outgoing angle of θ₂, and shields scattered light emitted at an angle greater than θ₁ and θ₂.

In this manner, the aperture 12 shields the scattered light emitted from the semiconductor laser 1 (the light emitted from the semiconductor laser 1 at an angle greater than the horizontal outgoing angle of θ₁ and the vertical outgoing angle of θ₂, that is, the light having an intensity of less than 1/e² of the peak value). Therefore, this structure can reduce the amount of the Fresnel reflection light caused on the light incoming and outgoing surfaces of the hologram device 2, which enters the photoreceptor 11 to be detected, by the amount of the shielded scattered light.

Meanwhile, the light 15 emitted from the semiconductor laser 1 at an angle not more than the horizontal outgoing angle of θ₁ and the vertical outgoing angle of θ₂, that is, the light 15 having an intensity of not less than 1/e² of the peak value, is emitted outside via the hologram device 2, without being interfered by the aperture 12. Therefore, the reliability of the control by the servo mechanism carried out in accordance with detected light can be substantially improved.

Here, it is preferable to process the inside of the cap 10 with reflection-free treatment, by metal plating or with a mat black resist pen, etc. This arrangement can further reduce the amount of the Fresnel reflection light which enters the photoreceptor 11 to be detected. Therefore, relative intensity of an error signal with respect to noise (S/N) can be increased, improving the servo mechanism in the optical pick-up device.

Since the aperture 12 is formed as an opening section of the cap 10, a simple structure can be realized, and thus there is no need to provide a device aside from the cap 10 or to process the aperture 12 separately. This structure restrains the increase in the number of parts in the optical pick-up device, reducing manufacturing cost.

Incidentally, the shape of the aperture 12 is not limited to those shown in FIGS. 2(a) and 2(b), and it may be a rectangular as shown in FIG. 2(c), or a ellipse or an oval figure as shown in FIG. 2(d), etc.

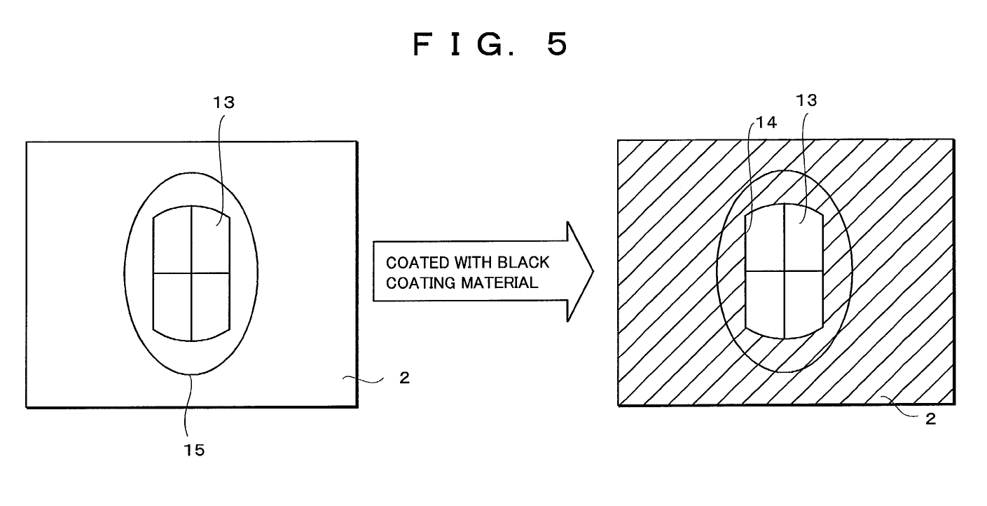

When the size of the hologram plane 13 is smaller than a light beam diameter of the light 15 emitted from the semiconductor laser 1, the part of the light 15 passing through a section outside the hologram plane 13 is not used as a servo signal. Therefore, as shown in FIG. 5, by providing black coating at the section outside the hologram plane 13 in the hologram device 2, only the hologram plane 13 can serve as an aperture 14, an opening section. Thus, the undesired stray light can be eliminated.

### Second Embodiment

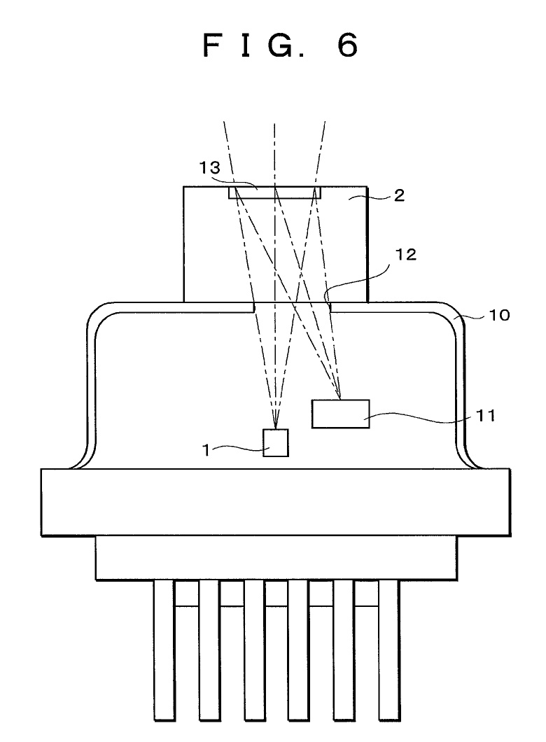

Referring to FIGS. 6 through 11, the following description will describe another embodiment of the present invention. The members having the same structure (function) as those in the first embodiment will be designated by the same reference numerals and their description will be omitted.

A semiconductor laser unit in accordance with the present embodiment is constituted by the semiconductor laser 1, the hologram device 2, the cap 10, and the photoreceptor 11, as in the first embodiment. While the hologram plane 13 is located so as to cover the aperture 12 of the cap 10 in the first embodiment, in the present embodiment, as shown in FIG. 6, the hologram plane 13 of the hologram device 2 is provided on the side opposite to the side in contact with the cap 10 (on the side opposite to the side to which the semiconductor laser 1 is provided). Here, the aperture 12 is formed in a rectangular shape.

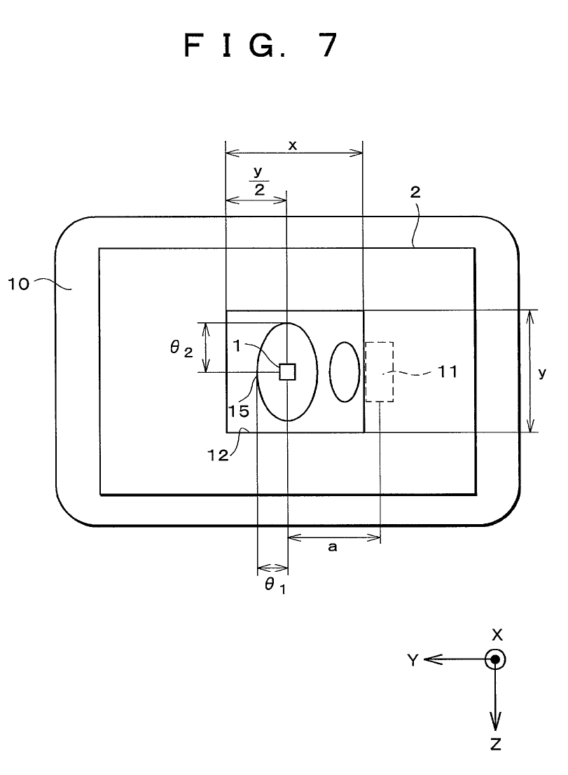

In this manner, the hologram plane 13 is provided on the side of a light outgoing surface in the semiconductor laser unit, so if the aperture 12 is formed in a square or a circular shape, it interferes with servo error signal light diffracted from the hologram device 2. Therefore, as shown in FIG. 7, the aperture 12, which is an opening section of the cap 10, is expanded in a diffraction direction only, so as to prevent servo error signal light from being interfered by the aperture 12.

To detect the servo error signal light without being interfered by the aperture 12, a longer side length x and a shorter side length y of the aperture 12 shown in FIG. 7 should satisfy the following inequalities (3) and (4):

y/2+a−(L₁−b)(a−(L₁+L₂/n)tanθ₁)/(L₁+L₂/n−b)<x<y/2+a . . . (3)

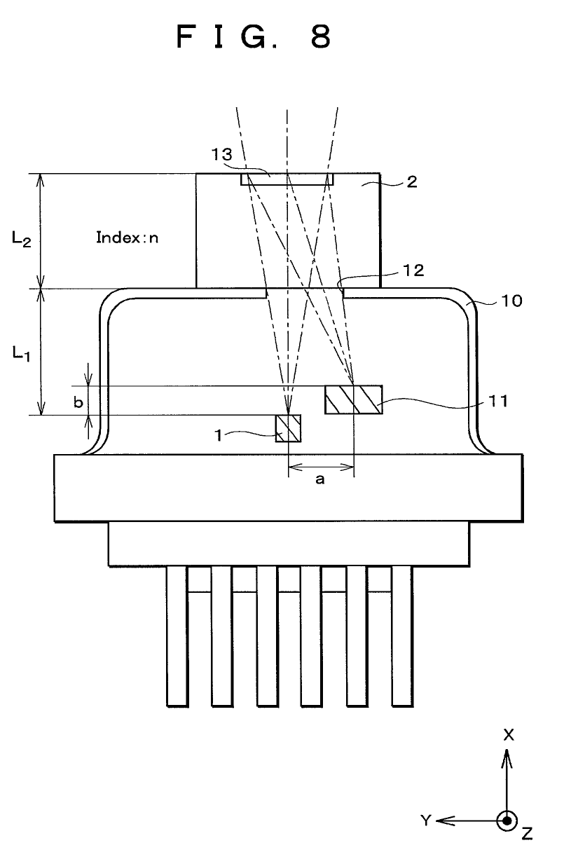

2L₁·tanθ₂<y<2.7L₁·tanθ₂ . . . (4)

where θ₁ and θ₂ are the horizontal and the vertical outgoing angles, respectively, of the light 15 having an intensity of not less than 1/e² of the peak value included in the laser light emitted from the semiconductor laser 1, as shown in FIG. 7; L₁ is a distance between the semiconductor laser 1 and the hologram device 2, L₂is a thickness of the hologram device 2, a and b are distances between the light emission point of the semiconductor laser 1 and the center of the light reception surface of the photoreceptor 11 in a diffraction direction and in a light axis direction, respectively, as shown in FIG. 8; and n is a refractive index of the hologram device 2.

In the conditions identical to that in the first embodiment, 1.26 mm<y<1.7 mm is obtained from the inequality (2), and when the value y=1.6 mm, within this range, is applied to the inequality (4), the following values are obtained:

x>y/2+a−(L₁−b)(a−(L₁+L₂/n)tanθ₁)/(L₁+L₂/n−b)=1.65 mm

x<y/2+a=2.0 mm.

Therefore, the range of the longer side length x of the aperture 12 is defined as 1.65 mm<x<2.0 mm.

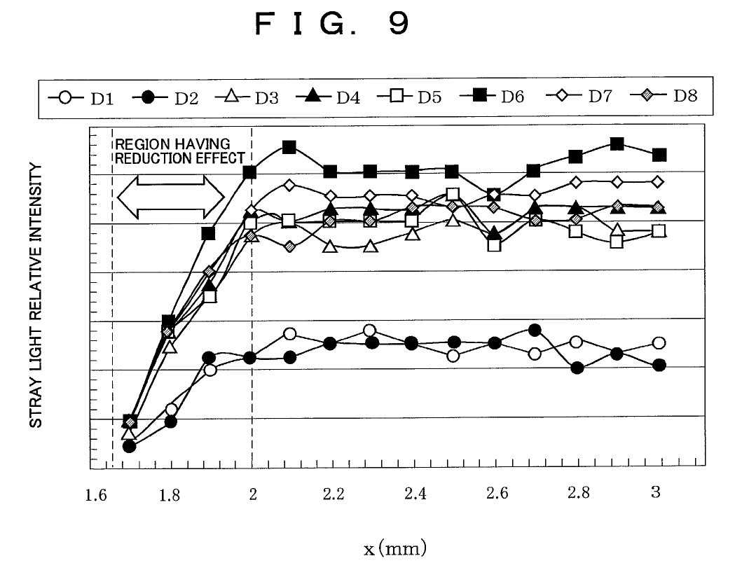

FIG. 9 is a graph of stray light intensity in the semiconductor laser unit shown in FIG. 6, obtained by simulation. The horizontal axis denotes the length of the longer side x of the aperture 12, and the vertical axis denotes the stray light relative intensity. According to the graph, when forming the aperture 12 with x=1.8 mm, the amount of the stray light decreases almost by half.

In this manner, the aperture 12 shields the scattered light emitted from the semiconductor laser 1 (the light emitted from the semiconductor laser 1 at an angle greater than the horizontal outgoing angle of θ₁ and the vertical outgoing angle of θ₂, that is, having an intensity of less than 1/e² of the peak value). Therefore, this structure can reduce the amount of the Fresnel reflection light caused on the light incoming and outgoing surfaces of the hologram device 2, which enters the photoreceptor 11 to be detected, without interfering with the servo error signal light diffracted on the hologram plane 13.

With this structure, relative intensity of an error signal with respect to noise can be increased, improving the servo mechanism in the optical pick-up device.

Since the aperture 12 is formed as an opening section of the cap 10, there is no need to provide a device aside from the cap 10 or to process the aperture 12 separately. This structure can reduce the manufacturing cost of the optical pick-up device.

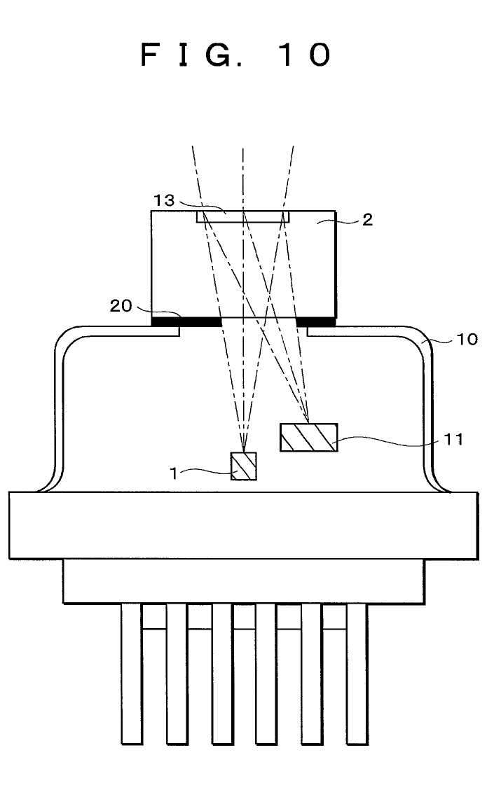

Instead of the aperture 12, which is the opening section of the cap 10, an aperture 20 with shielding property may be adhered and formed on the light incoming surface of the hologram device 2, as shown in FIG. 10. Here, the aperture 20 is coated with a mat black material such as a black resist pen or a black potting material for ICs. This arrangement can reduce the amount of the Fresnel reflection light caused by impinging on the hologram device 2, which enters the photoreceptor 11 to be detected, without an increase in the number of parts.

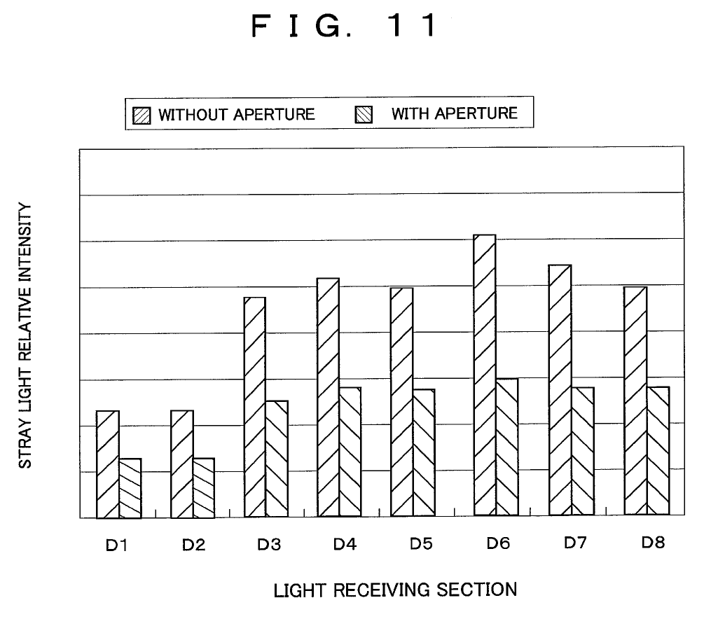

FIG. 11 is a graph showing the measured amount of stray light obtained when the aperture 20 formed as a rectangle having a longer side length x is provided, by coating the light incoming surface of the hologram device 2 with a black coating material, etc., and that obtained when the aperture 20 is not provided. Here, it is set as x=1.8 mm.

As shown in FIG. 11, the amount of the stray light is decreased almost by half when the aperture 20 is provided, as in the simulation result shown in FIG. 9.

In this manner, in the structure such that the aperture 20 is formed as a rectangle satisfying the foregoing inequalities (3) and (4), the Fresnel reflection light can be further prevented from entering the photoreceptor 11, without interfering with the servo error signal light. With this structure, a highly reliable servo mechanism can be surely provided.

Since the light emitted from the semiconductor laser 1 has an elliptical cross section having the horizontal outgoing angle θ₁ and the vertical outgoing angle θ₂, the aperture 12 or 20 may be formed in an elliptical or oval shape. When the aperture 12 or 20 has a smaller area, the aperture 12 or 20 can eliminate the stray light more effectively. Accordingly, the aperture 12 or 20 can eliminate the stray light more effectively when it is formed as, in order of an oval, an ellipse, and an rectangle.

As has been described, a semiconductor laser unit of the present invention, which is a semiconductor laser unit for emitting laser light from a semiconductor laser via a hologram device, and guiding the light incident on the hologram device to a photoreceptor, is characterized by taking the following step.

That is, the foregoing semiconductor laser unit is characterized by including scattered light shielding means for shielding scattered light having an intensity of less than 1/e² of a peak value included in the laser light emitted from the semiconductor laser.

In the foregoing semiconductor laser unit, the laser light is emitted from the semiconductor laser to the outside via the hologram device. Meanwhile, the light emitted to the hologram device is diffracted by the hologram device and guided to the photoreceptor.

Laser light is emitted from the semiconductor laser. The laser light includes light having an intensity of not less than 1/e² of the peak value, which has an elliptical cross section, and it also includes scattered light having an intensity of less than 1/e² of the peak value. The scattered light enters the photoreceptor in several ways: it enters the photoreceptor directly; it is reflected on the light incoming and outgoing surfaces of the hologram device, then enters the photoreceptor directly or indirectly as the Fresnel reflection light; or it is reflected at a material in the semiconductor laser unit (for example, on an inner surface of a cap) and enters the photoreceptor. Among the foregoing scattered light entering the photoreceptor, the Fresnel reflection light reflected on the light incoming and outgoing surfaces of the hologram device and enters the photoreceptor is predominant in terms of amount. When light other than the light which should be originally detected enters the photoreceptor, the detection accuracy of the photoreceptor is substantially deteriorated. Thus, if control (for example, the control by a servo mechanism) is carried out based on the light actually detected by the photoreceptor, reliability is significantly deteriorated.

Hence, according to the foregoing structure, the scattered light shielding means is provided so as to shield the scattered light having an intensify of less than 1/e² of the peak value. Therefore, the foregoing structure can surely reduce the amount of the scattered light entering the photoreceptor directly or indirectly, by the amount of the shielded scattered light. Meanwhile, a beam of the laser light having an intensity of not less than 1/e² of the peak value is emitted outside via the hologram device, without being interfered by the scattered light shielding means. Therefore, the reliability of the control carried out based on detected light can be substantially improved, without decreasing the intensity of the emitted light.

The foregoing semiconductor laser unit is structured such that the scattered light shielding means is an aperture. According to this structure, the amount of the scattered light entering the photoreceptor directly or indirectly can be surely reduced with a simple structure.

The foregoing semiconductor laser unit is structured such that a hologram plane of the hologram device is in contact with the aperture, and the aperture is formed in a square, a rectangular, a circular, an elliptical, or an oval shape.

Since the light emitted from the semiconductor laser has an elliptical cross section having a horizontal outgoing angle and a vertical outgoing angle, by forming the aperture in the above-mentioned shape, the foregoing structure can prevent the aperture from interfering with the light emitted in a direction of a major axis of the elliptical cross section.

The foregoing semiconductor laser unit is structured such that, when the aperture is formed in, for example, a square or a circular shape, the aperture is formed as a square having a side of Aₚ or a circle having a diameter of Aₚ, and Aₚ satisfies:

Aₚ>2L₁·tanθ₂,

where θ₂ is a vertical outgoing angle, which is a half angle of an outgoing angle corresponding to a major axis of a portion, which has an elliptical cross section, and has an intensity of not less than 1/e² of the peak value, of the laser light emitted from the semiconductor laser; and

L₁ is a distance between the semiconductor laser and the hologram device.

This structure can prevent the aperture from interfering with the light emitted from the semiconductor laser.

The foregoing semiconductor laser unit is structured such that the aperture is formed at a part of the cap whose inside is processed with reflection-free treatment. This structure can surely reduce the amount of the Fresnel reflection light caused by impinging on the hologram device, which enters the photoreceptor, without an increase in the number of parts.

The foregoing semiconductor laser unit is structured such that, the aperture is formed as a square having a side of Aₚ or a circle having a diameter of Aₚ, and Aₚ satisfies:

2L₁·tanθ₂<Aₚ<2.7L₁·tanθ₂,

where θ₂ is a vertical outgoing angle, which is a half angle of an outgoing angle corresponding to a major axis of a portion, which has an elliptical cross section, and has an intensity of not less than 1/e² of the peak value, of the laser light emitted from the semiconductor laser; and

L₁ is a distance between the semiconductor laser and the hologram device.

This structure can surely reduce the amount of the Fresnel reflection light caused by impinging on the hologram device, which enters the photoreceptor.

The foregoing semiconductor laser unit is structured such that the aperture is formed in a shape corresponding to only a hologram section of the hologram device.

This structure can cope with a case where the size of the hologram device is smaller than a light beam diameter of the light emitted from the semiconductor laser. Thus, undesired stray light can be eliminated.

The foregoing semiconductor laser unit is structured such that the hologram plane of the hologram device is provided on the side opposite to the side to which the semiconductor laser is provided, and the aperture is formed in a rectangular shape having a longer side in a diffraction direction, or an elliptical or an oval shape having a major axis in a diffraction direction.

When the hologram plane of the hologram device is provided on the side opposite to the side to which the semiconductor laser is provided, if the aperture is formed in a square or a circular shape, light diffracted from the hologram device cannot reach the photoreceptor.

Hence, as mentioned above, the aperture is formed in a rectangular shape having a longer side in a diffraction direction, or an elliptical or an oval shape having a major axis in a diffraction direction, enabling the diffracted light to reach the photoreceptor with reliability.

The foregoing semiconductor laser unit is structured so as to satisfy:

y/2+a−(L₁−b)(a−(L₁+L₂/n)tanθ₁)/(L₁+L₂/n−b)<x<y/2+a

and

2L₁·tanθ₂<y<2.7L₁·tanθ₂,

where θ₁ is a horizontal outgoing angle, which is a half angle of an outgoing angle corresponding to a minor axis of a portion, which has an elliptical cross section, and has an intensity of not less than 1/e² of the peak value, of the laser light emitted from the semiconductor laser;

θ₂ is a vertical outgoing angle, which is a half angle of an outgoing angle corresponding to a major axis of a portion, which has the elliptical cross section, and has an intensity of not less than 1/e² of the peak value, of the laser light emitted from the semiconductor laser;

L₁ is a distance between the semiconductor laser and the hologram device;

L₂is a thickness of the hologram device;

a and b are distances between the light emission point of the semiconductor laser and the center of the light reception surface of the photoreceptor in a diffraction direction and in a light axis direction, respectively;

n is a refractive index of the hologram device; and

x and y are a longer side length and a shorter side length of the aperture, respectively.

This structure provides a smaller area of a region in the aperture where light does not pass through, further surely preventing the Fresnel reflection light from entering the photoreceptor.

The foregoing semiconductor laser unit is structured such that the aperture is adhered and formed on a light incoming surface of the hologram device.

This structure can prevent the stray light subjected to the Fresnel reflection caused in the hologram device from entering the photoreceptor.

The foregoing semiconductor laser unit is structured such that the aperture is formed as an opening section provided at the cap which houses the semiconductor laser and the photoreceptor.

With this structure, there is no need to provide a device aside from the cap or to process the aperture separately. Therefore, this structure can reduce the number of parts of an optical pick-up device, reducing manufacturing cost.

An optical pick-up device of the present invention is structured such that, adopting the foregoing semiconductor laser unit, light emitted from the semiconductor laser unit is guided to a recording medium, and light reflected from the recording medium is guided to the photoreceptor via the hologram device, so as to detect a servo error signal.

This structure can reduce stray light which is caused from the recording medium and enters the photoreceptor, without interfering with servo error signal detection light diffracted by the hologram device. Therefore, a highly reliable servo mechanism can be surely provided.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A semiconductor laser unit for emitting laser light from a semiconductor laser via a hologram device, and guiding light incident on said hologram device to a photoreceptor, comprising:
scattered light shielding means for shielding scattered light having an intensity of less than 1/e² of a peak value, of the laser light emitted from said semiconductor laser.

2. The semiconductor laser unit of claim 1, wherein:
said scattered light shielding means is an aperture.

3. The semiconductor laser unit of claim 2, wherein:
a hologram plane of said hologram device is in contact with said aperture; and
said aperture is formed in a square, or a circular shape.

4. The semiconductor laser unit of claim 3, wherein:
said aperture is f ormed at a part of a cap whose inside is processed with reflection-free treatment.

5. The semiconductor laser unit of claim 2, wherein:
a hologram plane of s aid hologram device is in contact with said aperture; and
said aperture is formed in a rectangular, an elliptical, or an oval shape.

6. The semiconductor laser unit of claim 5, wherein:
said aperture is formed at a part of a cap whose inside is processed with reflection-free treatment.

7. The semiconductor laser unit of claim 3, wherein:
said aperture is formed as a square having a side of Aₚ or a circle having a diameter of Aₚ; and
Aₚ satisfies Aₚ>2L₁·tanθ₂,
where θ₂ is a vertical outgoing angle, which is a half angle of an outgoing angle corresponding to a major axis of a portion, which has an elliptical cross section, and has an intensity of not less than 1/e² of the peak value, of the laser light emitted from said semiconductor laser; and
L₁ is a distance between said semiconductor laser and said hologram device.

8. The semiconductor laser unit of claim 3, wherein:
said aperture is formed as a square having a side of Aₚ or a circle having a diameter of Aₚ, and
Aₚ satisfies 2L₁·tanθ₂<Aₚ<2.7L₁·tanθ₂,
where θ₂ is a vertical outgoing angle, which is a half angle of an outgoing angle corresponding to a major axis of a portion, which has an elliptical cross section, and has an intensity of not less than 1/e² of the peak value, of the laser light emitted from said semiconductor laser; and
L₁ is a distance between said semiconductor laser and said hologram device.

9. The semiconductor laser unit of claim 2, wherein:
said aperture is formed in a shape corresponding to only a hologram section of said hologram device.

10. The semiconductor laser unit of claim 9, wherein:
said hologram device is coated with a black coating material in regions other than said hologram section.

11. The semiconductor laser unit of claim 2, wherein:
a hologram plane of said hologram device is provided on a side opposite to a side to which said semiconductor laser is provided; and
said aperture is formed in a rectangular shape having a longer side in a diffraction direction, or an elliptical or an oval shape having a major axis in a diffraction direction.

12. The semiconductor laser unit of claim 11, satisfying:
y/2+a−(L₁−b)(a−(L₁+L₂/n)tanθ₁)/(L₁+L₂/n−b)<x<y/2+a and
2L₁·tanθ₂<y<2.7L₁·tanθ₂,
where θ₁ is a horizontal outgoing angle, which is a half angle of an outgoing angle corresponding to a minor axis of a portion, which has an elliptical cross section, and has an intensity of not less than 1/e² of the peak value, of the laser light emitted from said semiconductor laser;
θ₂ is a vertical outgoing angle, which is a half angle of an outgoing angle corresponding to a major axis of a portion, which has an elliptical cross section, and has an intensity of not less than 1/e² of the peak value, of the laser light emitted from said semiconductor laser;
L₁ is a distance between said semiconductor laser and said hologram device;
L₂is a thickness of said hologram device;
a and b are distances between a light emission point of said semiconductor laser and a center of a light reception surface of said photoreceptor in a diffraction direction and in a light axis direction, respectively;
n is a refractive index of said hologram device; and
x and y are a longer side length and a shorter side length of said aperture, respectively.

13. The semiconductor laser unit of claim 2, wherein:
said aperture is adhered and formed on a light incoming surface of said hologram device.

14. The semiconductor laser unit of claim 2, wherein:
said aperture is formed as an opening section provided at a cap which houses said semiconductor laser and said photoreceptor.

15. An optical pick-up device adopting a semiconductor laser unit for emitting laser light from a semiconductor laser via a hologram device, and guiding light incident on said hologram device to a photoreceptor, which comprises scattered light shielding means for shielding scattered light having an intensity of less than 1/e² of a peak value, of the laser light emitted from said semiconductor laser, wherein:
the light emitted from said semiconductor laser unit is guided to a recording medium, and light reflected from said recording medium is guided to said photoreceptor via said hologram device, so as to detect a servo error signal.

16. The optical pick-up device of claim 15, wherein:
said scattered light shielding means is an aperture.

17. The optical pick-up device of claim 16, wherein:
a hologram plane of said hologram device is in contact with said aperture; and
said aperture is formed in a square, or a circular shape.

18. The optical pick-up device of claim 17, wherein:
said aperture is formed at a part of a cap whose inside is processed with reflection-free treatment.

19. The optical pick-up device of claim 16, wherein:
a hologram plane of said hologram device is in contact with said aperture; and
said aperture is formed in a rectangular, an elliptical, or an oval shape.

20. The optical pick-up device of claim 19, wherein:
said aperture is formed at a part of a cap whose inside is processed with reflection-free treatment.

21. The optical pick-up device of claim 17, wherein:
said aperture is formed as a square having a side of Aₚ or a circle having a diameter of Aₚ; and
Aₚ satisfies Aₚ>2L₁·tanθ₂,
where θ₂ is a vertical outgoing angle, which is a half angle of an outgoing angle corresponding to a major axis of a portion, which has an elliptical cross section, and has an intensity of not less than 1/e² of the peak value, of the laser light emitted from said semiconductor laser; and
L₁ is a distance between said semiconductor laser and said hologram device.

22. The optical pick-up device of claim 17, wherein:
said aperture is formed as a square having a side of Aₚ or a circle having a diameter of Aₚ, and
Aₚ satisfies 2L₁·tanθ₂<Aₚ<2.7L₁·tanθ₂,
where θ₂ is a vertical outgoing angle, which is a half angle of an outgoing angle corresponding to a major axis of a portion, which has an elliptical cross section, and has an intensity of not less than 1/e² of the peak value, of the laser light emitted from said semiconductor laser; and
L₁ is a distance between said semiconductor laser and said hologram device.

23. The optical pick-up device of claim 16, wherein:
said aperture is formed in a shape corresponding to only a hologram section of said hologram device.

24. The optical pick-up device of claim 16, wherein:
a hologram plane of said hologram device is provided on a side opposite to a side to which said semiconductor laser is provided; and
said aperture is formed in a rectangular shape having a longer side in a diffraction direction, or an elliptical or an oval shape having a major axis in a diffraction direction.

25. The optical-pick up device of claim 24, satisfying:
y/2+a−(L₁−b)(a−(L₁+L₂/n)tanθ₁)/(L₁+L₂/n−b)<x<y/2+a and
2L₁·tanθ₂<y<2.7L₁·tanθ₂,
where θ₁ is a horizontal outgoing angle, which is a half angle of an outgoing angle corresponding to a minor axis of a portion, which has an elliptical cross section, and has an intensity of not less than 1/e² of the peak value, of the laser light emitted from said semiconductor laser;
θ₂ is a vertical outgoing angle, which is a half angle of an outgoing angle corresponding to a major axis of a portion, which has an elliptical cross section, and has an intensity of not less than 1/e² of the peak value included in the laser light emitted from said semiconductor laser;
L₁ is a distance between said semiconductor laser and said hologram device;
L₂is a thickness of said hologram device;
a and b are distances between a light emission point of said semiconductor laser and a center of a light reception surface of said photoreceptor in a diffraction direction and in a light axis direction, respectively;
n is a refractive index of said hologram device; and
x and y are a longer side length and a shorter side length of said aperture, respectively.

26. The optical pick-up device of claim 16, wherein:
said aperture is adhered and formed on a light incoming surface of said hologram device.

27. The optical pick-up device of claim 16, wherein:
said aperture is formed as an opening section provided at a cap which houses said semiconductor laser and said photoreceptor.
